(19) United States
(12) Patent Application Publication
(10) Pub. No.: US 2026/0011157 A1
(43) Pub. Date: Jan. 8, 2026

(54) METHOD FOR DETERMINING A LANE MARKING OF A LANE FOR A VEHICLE

(71) Applicant: Robert Bosch GmbH, Stuttgart (DE)

(72) Inventors: Axel Vogler, Stuttgart (DE); Stefan Kuenzel, Stuttgart (DE); Tamas Kapelner, Hildesheim (DE); Thomas Wenzel, Hamburg (DE); Azhar Sultan, Tunbridge Wells (GB); Joel Janai, Leonberg (DE)

(21) Appl. No.: 18/993,889

(22) PCT Filed: Jul. 27, 2023
(86) PCT No.: PCT/EP2023/070893

§ 371 Date: Jan. 13, 2025

(30) Foreign Application Priority Data
Aug. 12, 2022 (DE) 10 2022 208 429.2

(51) Int. Cl. G06V 20/56; G06T 7/60; G06V 10/766

(52) U.S. Cl. CPC G06V 20/588; G06T 7/60; G06V 10/766; G06T 2207/20081; G06T 2207/30172; G06T 2207/30256

(57) ABSTRACT

A method for determining a lane marking of a first lane for a vehicle. The method includes: providing measurement data from a monitoring of the surroundings of the vehicle; feeding the measurement data to at least one machine learning model; evaluating a course of the lane marking using the at least one machine learning model; evaluating a width of the lane marking using the at least one machine learning model. A method is also described for training at least one machine learning model for use in the above-mentioned method.

### FIELD

The present invention relates to a method for determining a lane marking for a vehicle. The present invention also relates to a method for training at least one machine learning model.

### BACKGROUND INFORMATION

Detection of a lane marking of a lane for a vehicle is an important aspect, in particular in the field of autonomous driving. The detection of a lane marking of a lane has so far been pursued using different technical approaches.

A first approach is based on a classic gradient method. In this approach, gradients are extracted from an image of the roadway taken via sensors and/or cameras located in a vehicle. From this, a lane marking of the lane in which the vehicle is located is ascertained. In this process, the inner and outer edge of the lane marking are ascertained and combined to calculate a width of a lane marking therefrom.

A second approach uses segment-based methods based on deep learning scenarios. In this approach, the outer and inner edges of a lane marking of a lane are likewise ascertained, namely, by estimating individual segment masks of the lane marking. However, the accuracy of this method essentially depends on the resolution of the segment masking used.

Another approach for ascertaining the lane marking of a lane is pursued by so-called anchor-based or anchor-free approaches. The goal is to use a direct or immediate representation of a line of the lane marking to be detected to model a center of the lane marking to be detected. This approach does indeed enable a higher accuracy in the exact ascertainment or determination of the position of the lane marking. However, in this approach, no direct conclusions can be drawn about the inner and outer edges of the lane marking to be detected.

### SUMMARY

According to a first aspect, the present invention relates to a method for determining a lane marking of a first lane for a vehicle. According to an example embodiment of the present invention, the method includes the following steps:

In a first step, measurement data are provided from monitoring the surroundings of the vehicle.

In a second step, the measurement data are supplied to at least one machine learning model.

In a third step, the course of the lane marking is evaluated using the at least one machine learning model.

In a fourth step, a width of the lane marking is evaluated using the at least one machine learning model.

Thus, the present invention offers the advantage that not only a center of a lane marking to be detected of a lane of a vehicle is modeled, but that a width of the lane marking to be detected of the lane of the vehicle is also recorded or estimated at each point in time. This is done by adding or solving a corresponding regression problem.

The solution approach pursued in according with the present invention may achieve the advantage of a higher accuracy in ascertaining the lane marking than in conventional approaches, as the center of the lane marking to be detected of a lane is also determined.

A further advantage is that all lane markings can be represented or determined by the approach according to the present invention.

A further advantage of the solution according to the present invention is that a regression problem for a width of the lane marking to be detected is much easier to solve than continuously estimating an inner and outer edge of a lane marking. This is because the width of the lane marking to be ascertained can be ascertained relative to a centerline or reference line of the lane, thereby rendering the method according to the present invention independent of a position or location of the lane marking in a captured image.

One possible embodiment of the method of the present invention provides that the course indicates a centerline of the lane marking in discrete or continuous form. This achieves the advantage of greater accuracy in ascertaining the lane marking.

One possible embodiment of the method of the present invention provides that the width of the lane marking is determined by regression. This achieves the advantage that the width of the lane marking can be efficiently ascertained.

One possible embodiment of the method of the present invention provides that a sub-area of the lane marking closest to the vehicle is selected for the regression. This achieves the advantage that the width of the lane marking can be efficiently ascertained.

One possible embodiment of the method of the present invention provides that regression is performed at multiple locations along the lane marking and the ascertained widths are aggregated to an end result for the width of the lane marking. This further reduces the error in ascertaining the width of the lane marking.

One possible embodiment of the method of the present invention provides that the course is indicated in the form of distances to a reference line through the monitored area of the surroundings of the vehicle. This achieves the advantage that the width of the lane marking can be ascertained efficiently and with high accuracy.

One possible embodiment of the method of the present invention provides that the image data and/or video data are selected as measurement data. These are the most important measurement modalities for detecting lane markings.

One possible embodiment of the method of the present invention provides that the step of evaluating the width of the lane marking of the first lane comprises the following steps:

In a first step, a position along the course of the lane marking is selected.

In a second step, a search is carried out in a predetermined search direction relative to the course of the lane marking for two boundary points between the lane marking on the one hand and the lane surface on the other hand.

In a third step, the width of the lane marking is ascertained from a distance between the two boundary points.

One possible embodiment of the method of the present invention provides that camera calibration data and/or information on the road condition of the first lane are considered in determining the width of the lane marking of the first lane. This can further increase the accuracy.

According to a second aspect, the present invention relates to a method for training at least one machine learning model for use in the method described above, with the following steps:

In a first step, training examples of measurement data that were captured from the perspective of an ego vehicle and that are indicative of the presence of one or more lane markings are provided.

In a second step, a target course and a target width are provided at least for one lane marking that demarcates the lane currently traveled by the ego vehicle.

In a third step, the training examples are fed to the machine learning model to be trained so that this machine learning model determines a course and a width of the lane marking using the above.

In a fourth step, a deviation between this course and this width on the one hand, and the target course or the target width on the other hand, is evaluated using a predetermined cost function.

In a fifth step, parameters that characterize the behavior of the machine learning model are optimized with the goal that the evaluation using the cost function is expected to improve with further processing of training examples.

The width of a lane marking that demarcates the lane currently traveled by the ego vehicle is the target width that can be determined most accurately within the context of the label because this lane marking is closest to the ego vehicle. It is therefore advantageous to use only this target width. Of course, it always tends to be better to have multiple labeled training examples available. However, if, for example, a lane marking farther away is labeled with a target width that is only inaccurately determined, these noisy labels can adversely impact the success of the training.

One possible embodiment of the method of the present invention provides that at least one target course is provided and a course is ascertained for at least one further lane marking that does not demarcate the lane currently traveled by the ego vehicle, and that the cost function also evaluates the deviation of this course from its target course. This achieves the advantage that the method can also be efficiently used and/or transferred to ascertain further lane markings that are not in the currently traveled lane.

One possible embodiment of the method of the present invention provides for the exclusion of at least one lane marking that can be seen from the measurement data by setting its contribution to the cost function to zero. This can make it possible to hide this lane marking more efficiently than by removing it from the measurement data of the training example.

According to a third aspect, the present invention relates to a computer program comprising machine-readable instructions which, when executed on one or more computers and/or computer instances, cause said computers and/or computer instances to carry out the method according to the present invention.

According to a fourth aspect, the present invention relates to a machine-readable data carrier and/or download product comprising the computer program.

According to a fifth aspect, the present invention relates to one or more computers and/or computer instances comprising the computer program and/or comprising the machine-readable data carrier and/or the download product.

Further measures improving the present invention are described in more detail below with reference to figures, together with the description of the preferred embodiment examples of the present invention.

### BRIEF DESCRIPTION OF THE DRAWINGS

FIG. 1 shows a schematic flowchart of the method for determining a lane marking of a first lane for a vehicle, according to an example embodiment of the present invention.

FIG. 2 shows a schematic flowchart of the method for training at least one machine learning model for use in the method according to FIG. 1, according to an example embodiment of the present invention.

FIG. 3 shows an example illustration of a conventional method for ascertaining a center of a lane marking for a lane of a vehicle.

FIG. 4 shows an example illustration of a method according to the present invention for ascertaining a width of a lane marking for a lane of a vehicle, according to an example embodiment of the present invention.

FIG. 5 shows an example illustration of providing a target position and a target width of a lane marking for a lane of a vehicle, according to an example embodiment of the present invention.

### DETAILED DESCRIPTION OF EXAMPLE EMBODIMENTS

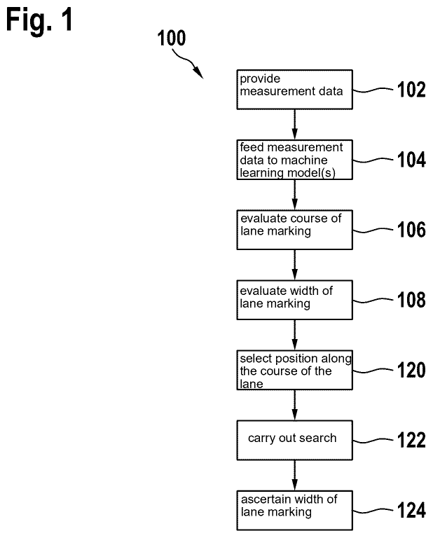

FIG. 1, referring to FIG. 3, shows a schematic flowchart of the method 100 for determining a lane marking 2 of a first lane 1 for a vehicle 10, with the following steps:

In a first step 102, measurement data are provided from monitoring the surroundings of the vehicle 10.

In a second step 104, the measurement data are fed to at least one machine learning model.

In a third step 106, a course of the lane marking is evaluated using the at least one machine learning model.

In a fourth step 108, a width 3 of the lane marking 2 is evaluated using the at least one machine learning model.

The evaluation of the width 3 of the lane marking 2 of the first lane 1 in the fourth step 108 is preferably carried out with the following steps:

In a first step 120, a position along the course of the lane marking 2 of the lane 1 is selected.

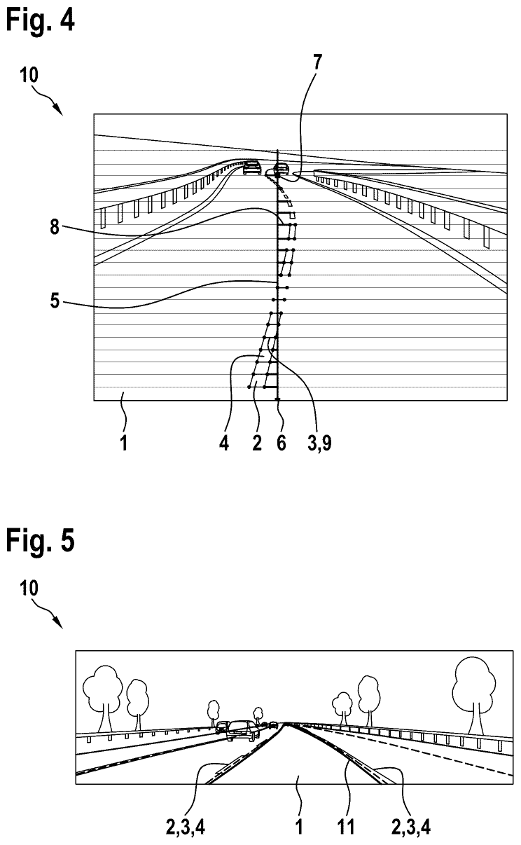

In a second step 122, a search is carried out in a predetermined search direction relative to the course of the lane marking 2 for two boundary points—see the line segment 9 in FIG. 4—between the lane marking 2 on the one hand and the lane surface on the other hand.

In a third step 124, the width 3 of the lane marking 2 of lane 1 or first lane 1 is ascertained from a distance between the two boundary points.

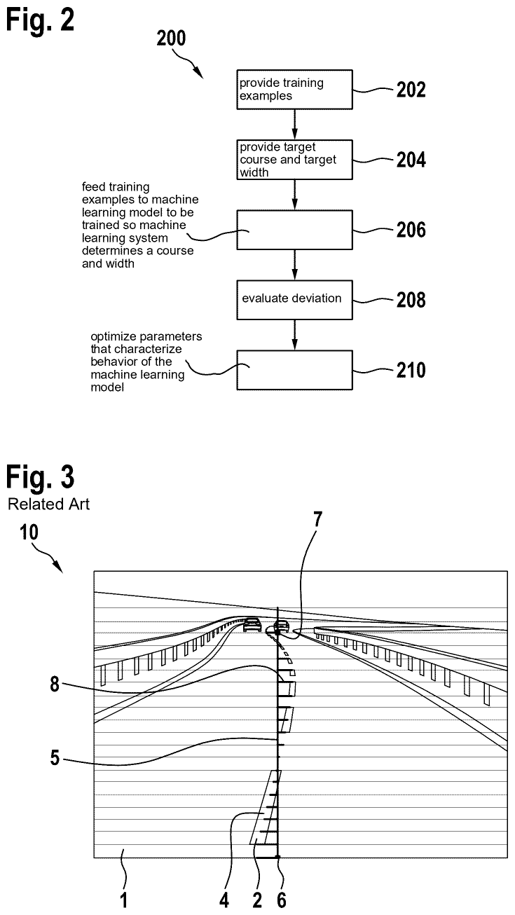

FIG. 2 shows a schematic flowchart of the method 200 for training at least one machine learning model for use in the method 100 according to FIG. 1 with the following steps:

In a first step 202, training examples of measurement data captured from the perspective of an ego vehicle 10 indicative of the presence of one or more lane markings are provided.

In a second step 204, a target course and a target width are provided at least for a lane marking that demarcates the lane currently traveled by the ego vehicle 10.

In a third step 206, the training examples are fed to the machine learning model to be trained so that this machine learning model determines a course and a width 3 of the lane marking 2 using the method according to the present invention. In a fourth step 208, a deviation between this course and this width 3 on the one hand, and the target course or the target width on the other hand, is evaluated using a predetermined cost function.

In a fifth step 210, parameters that characterize the behavior of the machine learning model are optimized with the goal that the evaluation using the cost function is expected to improve with further processing of training examples.

FIG. 3 shows an example illustration of an image taken by an (ego) vehicle 10 for the application of a conventional method for ascertaining a center of a lane marking 2 for a lane 1 of the vehicle 10 using an anchor-based approach. Between the starting point 6 and the end point 7 of a reference line 5, the individual distances between the individual line sections or the individual line segments 8 and the respective center 4 of the lane marking 2 of the lane 1 are ascertained in horizontal direction for each point via regression.

FIG. 4 shows, by way of example, how the method 100 proposed here for ascertaining a width 3 of a lane marking 2 for a lane 1 of a vehicle 10 can be performed on the same captured image. In this method, described in simple words, starting from the reference line 5, which runs between a starting point 6 and an end point 7, the respective width 3 of the lane marking 2 of the lane 1 is ascertained in the horizontal direction according to the following steps of the method 100 as follows:

In a first step 102, measurement data are provided from monitoring the surroundings of the vehicle 10, here in the form of the captured image. The measurement data can generally be provided as image data and/or video data from corresponding sensors or other technical detection devices (not shown) of the vehicle 10.

In a second step 104, the measurement data are fed to at least one machine learning model. Multiple models can also be used, for example a first model can be provided for ascertaining the course of the lane marking 2 of the lane 1 and a second model for ascertaining the width 3 of the lane marking 2 of the lane 1.

In a third step 106, a course of the lane marking 2 is evaluated using the at least one machine learning model. The course can be, for example, a centerline 4, but also an edge. The course of the centerline 4 can in particular be indicated in the form of multiple discrete positions, for example. The course of the centerline 4 can also be indicated in a continuous form. The course of the centerline 4 can preferably—and as shown in FIG. 4—be indicated in the form of distances of the individual line segments 9 of the lane marking 2 to the reference line 5 through the monitored area of the surroundings of the vehicle 10.

In a fourth step 108, a width 3 of the lane marking 2 is evaluated using the at least one machine learning model. Preferably, the width 3 of the lane marking 2 of the lane 1 is determined by regression. In particular, a so-called scalar regression can be used here, because it can be carried out at a higher speed and provides more precise results since, with a given pixel resolution of a vehicle camera, the lane marking 2 appears larger. To determine the width 3 of the lane marking 2 of the first lane 1, camera calibration data and/or information on the road condition of the first lane 1 can preferably also be considered.

The regression can preferably be performed at multiple locations along the lane marking 2, wherein the ascertained widths are aggregated to a final result for the width 3 of the lane marking 2. A corresponding weighting with the distance to the vehicle 10 can be carried out to take into account a different degree of accuracy.

The evaluation of the width 3 of the lane marking 2 of the first lane 1 in the fourth step 108 is preferably carried out with the following steps:

In a first step 120, a position along the course of the lane marking 2 of the lane 1 is selected.

In a second step 122, a search is carried out in a predetermined search direction relative to the course of the lane marking 2 for two boundary points—see the line segment 9 in FIG. 4—between the lane marking 2 on the one hand and the lane surface on the other hand.

In a third step 124, the width 3 of the lane marking 2 of the lane 1 or the first lane 1, respectively, is ascertained from a distance between the two boundary points. FIG. 5 shows an example of how a target position and a target width of a lane marking 2 for a lane 1 of a vehicle 10 can be obtained. FIG. 5 shows how the center 4 of the lane marking of the lane 1 of the ego vehicle 1—dashed line—and the inner edge 11 of the lane marking 2 are marked correspondingly. These markings can be used to ascertain a target width of a lane marking that demarcates the lane currently traveled by the ego vehicle 10. This target width can be used to label training examples for the machine learning model.

1-15. (canceled)

16. A method for determining a lane marking of a first lane for a vehicle, comprising the following steps:
providing measurement data from a monitoring of the surroundings of the vehicle;
feeding the measurement data to at least one machine learning model;
evaluating a course of the lane marking using the at least one machine learning model; and
evaluating a width of the lane marking using the at least one machine learning model.

17. The method according to claim 16, wherein the course indicates a centerline of the lane marking in discrete or continuous form.

18. The method according to claim 16, wherein the width of the lane marking is determined by regression.

19. The method according to claim 18, wherein a sub-area of the lane marking closest to the vehicle is selected for the regression.

20. The method according to claim 18, wherein the regression is performed at multiple locations along the lane marking and the determined widths are aggregated to a final result for the width of the lane marking.

21. The method according to claim 16, wherein the course is indicated in a form of distances to a reference line through the monitored area of the surroundings of the vehicle.

22. The method according to claim 16, wherein the measurement data are image data and/or video data.

23. The method according to claim 16, wherein the step of evaluating the width of the lane marking of the first lane includes the following steps:
selecting a position along the course of the lane marking;
searching in a predetermined search direction relative to the course of the lane marking for two boundary points between the lane marking on the one hand and the lane surface on the other hand; and
ascertaining the width of the lane marking from a distance between the two boundary points.

24. The method according to claim 16, wherein camera calibration data and/or information regarding a road condition of the first lane are considered in determining the width of the lane marking of the first lane.

25. A method for training at least one machine learning model, comprising the following steps:
providing training examples of measurement data captured from a perspective of an ego vehicle indicating a presence of one or more lane markings;
providing a target course and a target width at least for one lane marking that demarcates the lane currently traveled by the ego vehicle;
feeding the training examples to the machine learning model to be trained, so that this machine learning model determines a course and a width of the lane marking by:
evaluating the course of the lane marking using the at least one machine learning model, and
evaluating the width of the lane marking using the at least one machine learning model;
evaluating a deviation between the course and this width on the one hand, and the target course or the target width on the other hand, using a predetermined cost function; and
optimizing parameters that characterize a behavior of the machine learning model with a goal that the evaluation using the cost function is expected to improve with further processing of training examples.

26. The method according to claim 25, wherein
at least one target course is provided and one course is ascertained for at least one further lane marking that does not demarcate the lane currently being traveled by the ego vehicle; and
the cost function also evaluates a deviation of the course from the target course.

27. The method according to claim 25, wherein at least one lane marking evident from the measurement data are left out of consideration by setting its contribution to the cost function to zero.

28. A non-transitory machine-readable data carrier on which is stored a computer program for determining a lane marking of a first lane for a vehicle, the computer program, when executed by one or more computers and/or computer instances, cause the one or more computers and/or computer instances to perform the following steps:
providing measurement data from a monitoring of the surroundings of the vehicle;
feeding the measurement data to at least one machine learning model;
evaluating a course of the lane marking using the at least one machine learning model; and
evaluating a width of the lane marking using the at least one machine learning model.

29. One or more computers and/or computer instances with a non-transitory machine-readable data carrier on which is stored a computer program for determining a lane marking of a first lane for a vehicle, the computer program, when executed by the one or more computers and/or computer instances, cause the one or more computers and/or computer instances to perform the following steps:
providing measurement data from a monitoring of the surroundings of the vehicle;
feeding the measurement data to at least one machine learning model;
evaluating a course of the lane marking using the at least one machine learning model; and
evaluating a width of the lane marking using the at least one machine learning model.
